(19) United States
(12) Patent Application Publication
(10) Pub. No.: US 2023/0316182 A1
(43) Pub. Date: Oct. 5, 2023

(54) RESOURCE RECOMMENDATION SERVICE BASED ON USER EXPERTISE

(71) Applicant: Citrix Systems, Inc., Fort Lauderdale, FL (US)

(72) Inventors: Wenshuang Zhang, Nanjing (CN); Xuan Liu, Nanjing (CN); Zongpeng Qiao, Nanjing (CN); Pei Zhou, Nanjing (CN)

(21) Appl. No.: 17/658,473

(22) Filed: Apr. 8, 2022

Related U.S. Application Data
(63) Continuation of application No. PCT/CN2022/083538, filed on Mar. 29, 2022.

(51) Int. Cl. G06Q 10/06; G06F 3/0481; H04L 9/40

(52) U.S. Cl. CPC G06Q 10/06313; G06Q 10/0639; G06F 3/0481; H04L 63/0815

(57) ABSTRACT

A system and method for recommending resources to users based on user expertise. A disclosed method includes: extracting project and keyword data from interactions between a user and workspace applications; evaluating the project and keyword data to determine an expertise level of the user for at least one project; in response to a determined expertise level for the at least one project, determining a set of resources for the user based on historical workspace interactions of workspace users having a common expertise level; and outputting links to the set of resources to a virtual workspace of the user. Aspects analyze an expertise level for a topic and recommend resources at that level to reduce the learning curve. Aspects detect when a user is involved in a new project and determines and displays the expertise level. Resources recommended include, e.g., tools or applications, encountered problems and solutions, experts reported issues, etc.

### BACKGROUND OF THE DISCLOSURE

Virtual workspaces provide an effective platform for provisioning resources to users, including, e.g., applications, content, online help, etc. From the user's perspective, being able to quickly identify and obtain useful resources in a workspace increases efficiency and the overall user experience.

### BRIEF DESCRIPTION OF THE DISCLOSURE

Aspects of this disclosure include a system and method for recommending and presenting resources in a workspace based on a determined expertise level of the user. Further, as the expertise level of the user changes over time, the resources presented evolve to match the expertise level. Accordingly, aspects are disclosed that analyze a user's specific expertise level for a specific topic (i.e., project) and recommend target resources for the user at that level in order to reduce the learning curve for the user. Furthermore, aspects are disclosed that detect that the user is involved in a new field of endeavor (i.e., project) based on current tasks, communications, etc., and determines and displays the expertise level for the user. Once the expertise level is determined, resources are recommended for the user including, e.g., useful tools or applications, typically encountered problems and solutions, users having expertise, reported issues, etc.

A first aspect of the disclosure provides a system that includes a memory and a processor coupled to the memory and configured to suggest resources. Resources are suggested according to a process that includes extracting project and keyword data resulting from interactions between a user and system applications and evaluating the project and keyword data to determine an expertise level of the user for at least one project. In response to a determined expertise level for the at least one project, determining a set of resources for the user based on historical resource interactions of system users having a common expertise level and outputting links to the set of resources for the user.

A second aspect of the disclosure provides a method that includes extracting project and keyword data from interactions between a user and workspace applications and evaluating the project and keyword data to determine an expertise level of the user for at least one project. In response to a determined expertise level for the at least one project, determining a set of resources for the user based on historical workspace interactions of workspace users having a common expertise level and outputting links to the set of resources to a virtual workspace of the user.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative virtual workspace infrastructure having a resource generation service, in accordance with an illustrative embodiment.

FIG. 2 depict an illustrative workspace having a personal center for displaying recommended resources, in accordance with an illustrative embodiment.

FIG. 3 depicts a dropdown window for selecting expertise levels, in accordance with an illustrative embodiment.

FIG. 4 depicts an example of evolving expertise levels, in accordance with an illustrative embodiment.

FIG. 5 depicts a user-level database, in accordance with an illustrative embodiment.

FIG. 6 depicts a flow diagram for populating the user-level database of FIG. 5, in accordance with an illustrative embodiment.

FIG. 7 depicts a resource-level database, in accordance with an illustrative embodiment.

FIG. 8 depicts a flow diagram for populating the resource-level database of FIG. 7, in accordance with an illustrative embodiment.

FIG. 9 depicts a flow diagram for selecting resources to recommend to a user, in accordance with an illustrative embodiment.

FIG. 10 depicts a network infrastructure, in accordance with an illustrative embodiment.

FIG. 11 depicts a computing system, in accordance with an illustrative embodiment.

FIG. 12A is a block diagram of an example system in which resource management services may manage and streamline access by clients to resource feeds (via one or more gateway services) and/or software-as-a-service (SaaS) applications.

FIG. 12B is a block diagram showing an example implementation of the system shown in FIG. 12A in which various resource management services as well as a gateway service are located within a cloud computing environment.

FIG. 12C is a block diagram similar to that shown in FIG. 12B in which the available resources are represented by a single box labeled “systems of record,” and further in which several different services are included among the resource management services.

The drawings are intended to depict only typical aspects of the disclosure, and therefore should not be considered as limiting the scope of the disclosure.

### DETAILED DESCRIPTION OF THE DISCLOSURE

Embodiments of this disclosure provide technical solutions for recommending and displaying resources to users based on a determined expertise level of the user. In certain embodiments, a resource generation service is provided in a client-server environment such as a cloud and/or virtual workspace infrastructure that analyzes interactions between a current user and workspace applications and determines an expertise level of the user for one or more projects the user is involved with. Based on the determined expertise level for a given project, the current user is presented with resources within their workspace, such as useful applications, useful links, frequently asked questions or hot topics, training resources available, etc. Over time, as the user's knowledge of a project increases, e.g., based on keywords utilized or other actions taken by the user via the workspace, their expertise level increases, and new resources are recommended for the user. In some embodiments, resources for a given expertise level are based on historical interactions of all (or a group of) users of an enterprise utilizing the workspace infrastructure. For example, for a given company, the resource generation service can track and collect data relating to applications used, links accessed, problems reported, help channels utilized, questions asked, training resources used, etc., for employees at different expertise levels. Based on the collected data of the system users, resources can be recommended for the current user.

By personalizing resources recommended to users based on their expertise level, a user can more quickly gain expertise for a project to advance from a novice level to an expert level. Typically, users increase expertise (e.g., gain specific knowledge, manage project development, learn agile practices, etc.) by continuously engaging with resources to solve a series of problems. For example, when brought onto a new project, a novice will engage with certain resources, i.e., use certain applications, address certain problems, ask certain questions, seek certain training, etc. As their expertise grows, e.g., from a novice to a junior level, the user will start engaging with different resources to increase expertise. The process repeats or evolves as the user progresses from a novice to an expert level. Accordingly, resources presented to an expert would not necessarily be appropriate for a novice or junior level person. In most current typical environments that recommend resources, all users are presented with the same collection of resources (e.g., desktops, applications, files, etc.). Accordingly, current approaches fail to provide a technical solution that will facilitate expertise growth of the users. Described embodiments provide technical solutions in which targeted resources are recommended based on users' current expertise level to help the users reduce learning curves and grow quickly from novices to experts.

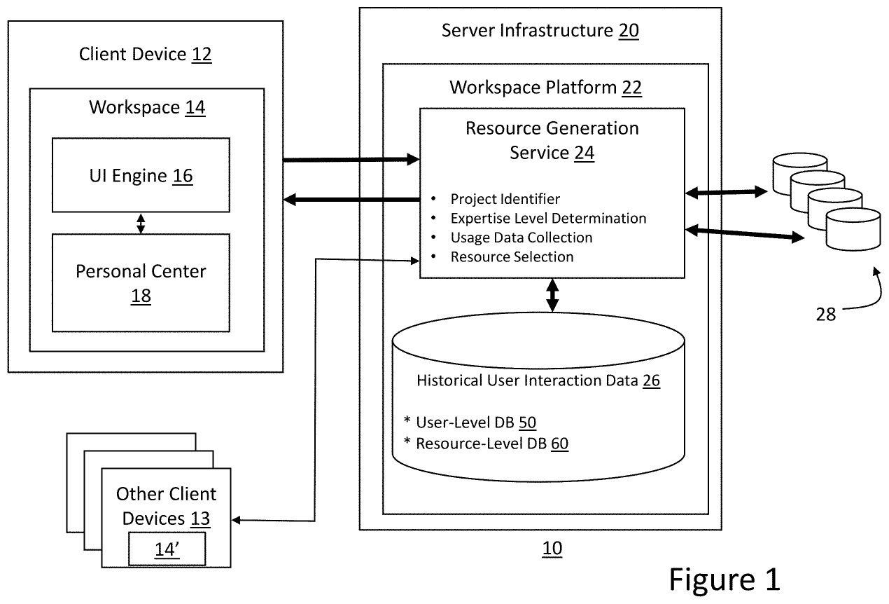

FIG. 1 depicts an illustrative virtual workspace infrastructure 10 having a server infrastructure 20 for implementing a workspace platform 22, and client devices 12, 13 that include virtual workspaces 14, 14′ to interact with workspace applications 28. Interactions with workspace applications 28 may for example be implemented with a single sign-on (SSO) authentication process. Although FIG. 1 shows an embodiment implemented as a virtual workspace infrastructure 10, it is understood that the resource generation service 24 could be implemented in any client-server or cloud-based environment. In this example, the client device 12 includes a workspace 14 rendered with a user interface (UI) engine 16. The workspace 14 includes a personal center 18 for displaying links to recommended resources for an associated user of the client device 12. Other client devices 13 include similar workspaces 14′ for displaying recommendations to their respective users.

To generate recommendations, workspace platform 22 includes a resource generation service 24 that determines and provides recommended resources to the workspaces 14, 14′ for associated users. Resource generation service 24 generally provides: (1) project identification; (2) expertise level determination for users; (3) usage data collection, which tracks and stores historical user interaction data 26; and (4) resource selection based on determined expertise levels. As described in further detail herein, resource generation service 24 examines interactions of a particular user with workspace applications 28 to identify projects the user is involved with, determine the expertise level of the particular user for the identified projects, and provide resource recommendations based on the determined expertise level. Illustrative workspace applications 28 include, e.g., email and calendaring applications such as OUTLOOK®, collaboration applications such as TEAMS®, product development applications such JIRA®, project management applications such as WRIKE®, search engines such as GOOGLE®, etc. In some embodiments, historical user interaction data 26 includes a user-level database (DB) 50 that tracks current expertise levels of users, and a resource-level database (DB) 60 that tracks historical resource interactions, i.e., which resources are being utilized by system users based on expertise levels. With these databases 50, 60, once an expertise level of a particular user is determined, resources can be selected for the particular user based on historical interactions of all (or a group of) users with a common expertise level.

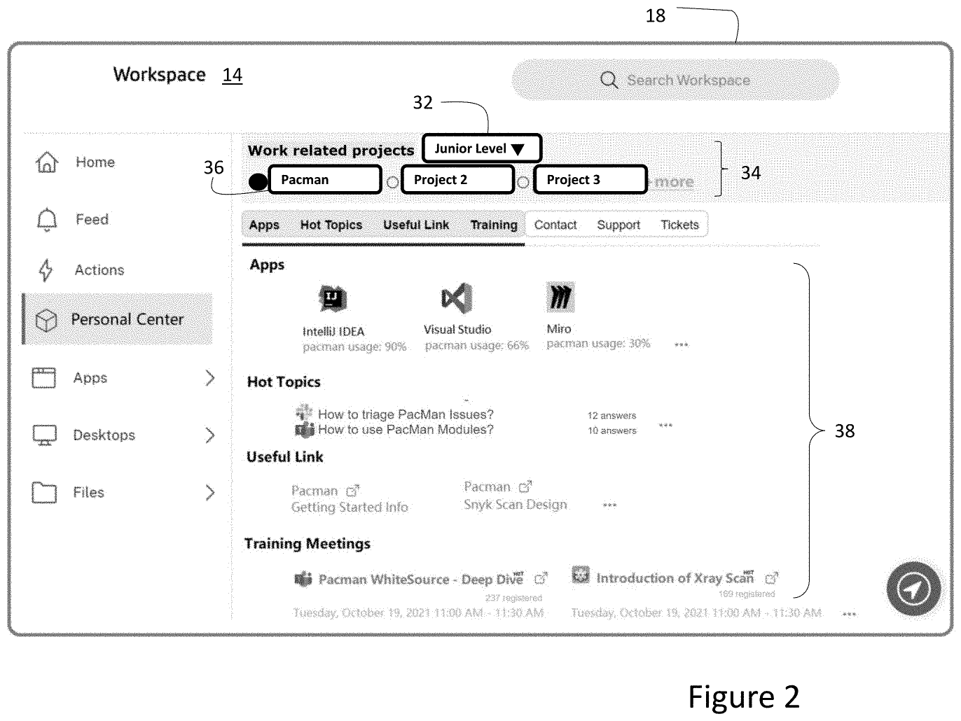

FIG. 2 depicts an illustrative view of a personal center 18 in workspace 14, rendered for a user of client device 12 (FIG. 1). In this example, three projects 34 are listed, Pacman, Project 2, and Project 3, with Pacman 36 being the selected project. Projects 34 may include any subject, category, topic, classification, etc., that is of interest or relevance to the user. In certain embodiments, projects 34 may be determined in an automated fashion, e.g., based on interactions of the user with the workspace 14. For example, projects can be determined based on applications used by the user, words or phrases used in communications, groups the user belongs to, etc. In other embodiments, projects may be manually selected by, or assigned to, the user.

In this example, the user's expertise level 32 is set as Junior Level for the Pacman 36 project. Different projects 34 associated with the user may however have different expertise levels. For example, the user may be at an Expert Level for Project 2 and a Novice Level for Project 3. In some embodiments, expertise levels may include Novice, Junior, Intermediate, Senior, and Expert. However, it is understood that any number of expertise levels may be utilized with any number of titles. Regardless, when a particular project is selected, e.g., Pacman 36, recommended resources 38 are displayed for the user for the associated expertise level, e.g., Junior Level. Recommended resources may for example be categorized as, e.g., applications (i.e., Apps), frequently asked questions (e.g., Hot Topics), useful links, and training resources (e.g., Training Meetings).

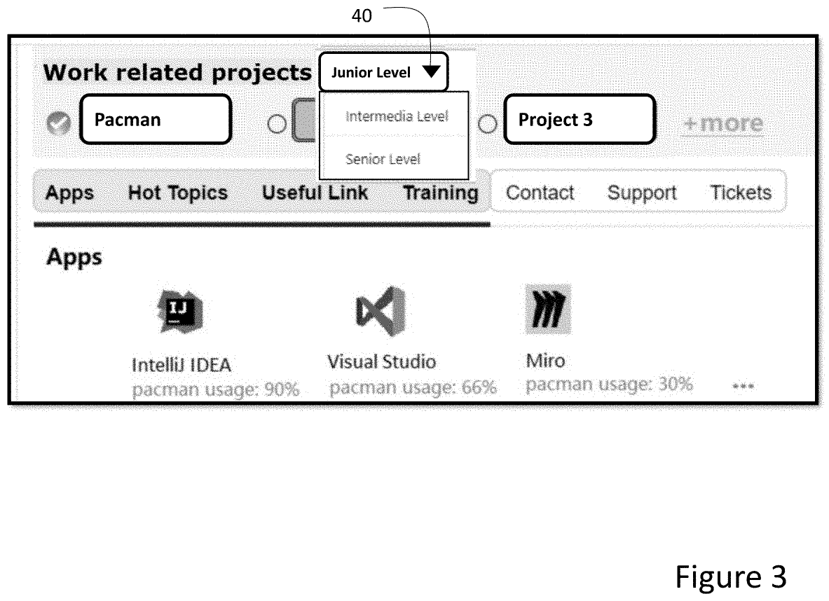

Furthermore, as shown in FIG. 3, the user can also manually override the expertise level for a project with a dropdown menu 40. When the expertise level is changed, the resulting resources 38 recommended to the user will be updated to reflect resources appropriate for the new expertise level.

Irrespective of the manual override feature, the expertise level for a project for the user is also automatically determined by the resource generation service 24 (FIG. 1), either periodically or on-demand when the user launches the personal center 18. In one embodiment, the expertise level is determined by analyzing interaction data (e.g., user entered data, user actions, user behaviors, etc.) of the user with the different workspace applications 28. In certain embodiments, this involves extracting project terms and keywords from data sources associated with the workspace applications 28 utilized by the user. For example, if the user sent a chat message in a collaboration application, “I'm looking for the latest sonar results for the pacman release,” the project term “pacman” and keyword “sonar’ could be extracted from a data source associated with the collaboration application. The extraction of terms and keywords could for example occur daily or on some other schedule. In one approach, natural language processing, such as a latent Dirichlet allocation (LDA) model, may be used to identify project terms and keywords from workspace application data and store the interaction results for the user, e.g., in a user-level database 50. An LDA model can be trained, e.g., by loading an existing data set, loading stop vocabulary, segmenting a document in the data set, filtering out noise words according to the stop list to generate a training set, and training the model based on the resulting training set. Once the model is trained, the model can be applied to existing data sources to identify project and keyword data. Open-source tools such as GENSIM may for example be utilized to perform these steps.

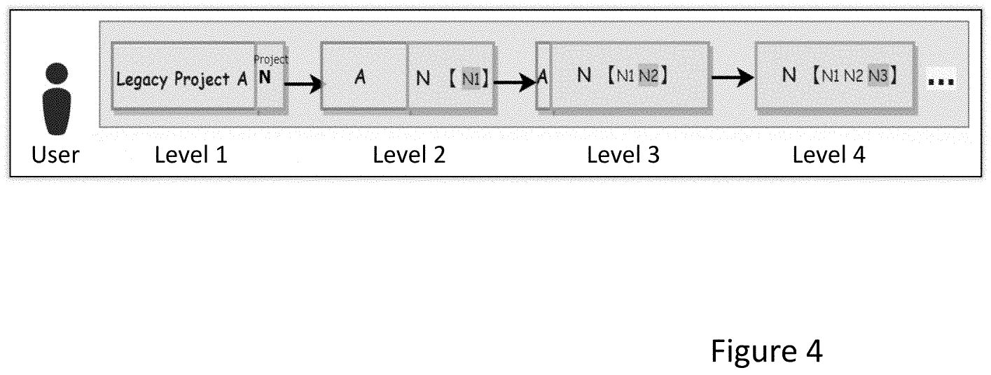

Initially, the user's expertise level may be set at novice for a new project. Then, based on an analysis of the identified project terms and keywords for the user, the expertise level can be increased. Often, users transition from an old/legacy project to new one and learning continuously deepens in the new project. As shown in FIG. 4, a user is evolving from a Legacy Project A to a new project N, so extracted key words may relate to either Project A or N. As the process deepens at each new phase of the transition, new key words N1, N2, N3 associated with project N will appear indicating the user's expertise in project N is increasing. In certain implementations, the resource generation service 24 (FIG. 1) can advance the user to a next expertise level after some frequency or threshold (e.g., one or more) number of keywords are detected. In some embodiments, the expertise level is advanced upon detection of a single new keyword (e.g., N1) associated with a project. In other cases, several instances of one or more keywords may be required to advance the expertise level.

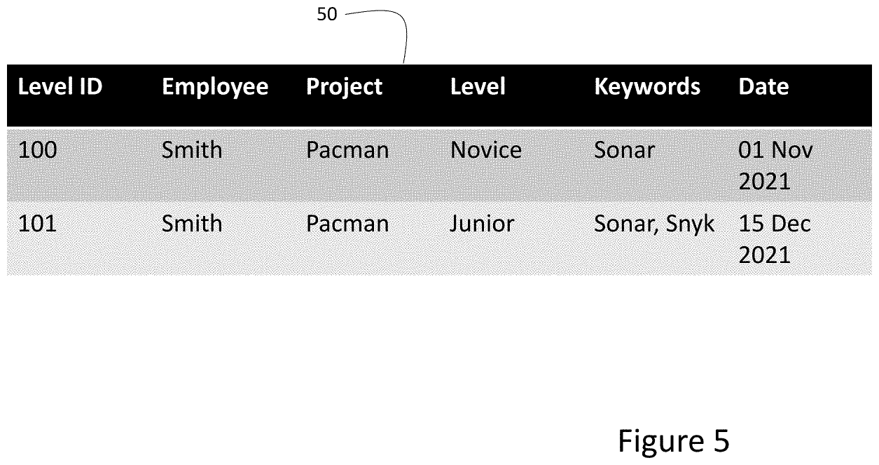

FIG. 5 depicts an illustrative user-level database 50 for storing detected keywords and tracking expertise levels for users (only one user shown in this example). In this case, employee Smith was determined to be at a Novice level (Level ID 100) starting on 1 Nov. 2021 when the keyword “Sonar” was detected for the project “Pacman.” Employee Smith was then advanced to a Junior Level on 15 Dec. 2021 when the keywords Sonar and Snyk were detected for the Pacman project.

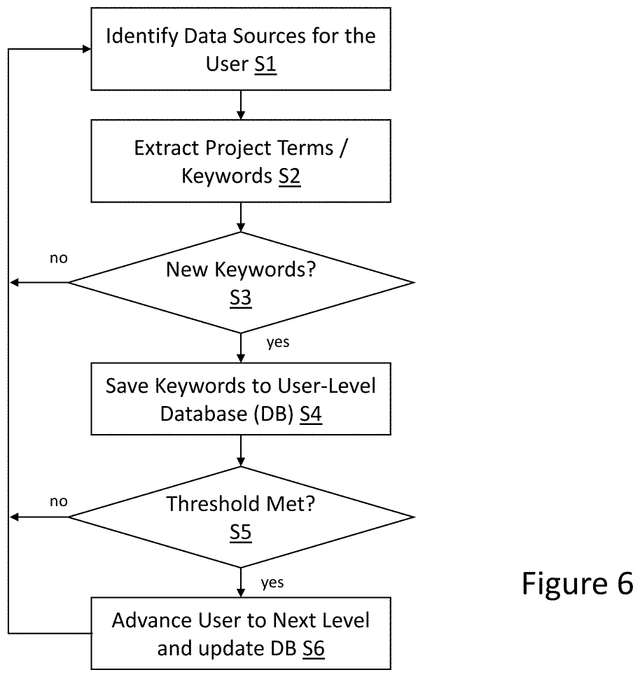

FIG. 6 depicts a flow diagram of an illustrative process for updating the user-level database 50 for a user. At S1, data sources for the user are identified, e.g., data associated with workspace applications 28 utilized by the user. At S2, term and keyword data are extracted from the data sources and at S3, a determination is made whether there are any new keywords since the last analysis. If no, the process loops back until a next analysis is performed. If yes, the keyword(s) are saved to the user-level database 50 and a determination is made at S5 whether a threshold or frequency is met for a number of new keywords. If no, the process loops back until a next analysis is performed. If yes, the user is advanced to a next expertise level and the user-level database 50 is updated at S6. The analysis shown in FIG. 6 may for example be implemented periodically, e.g., daily, weekly, etc.

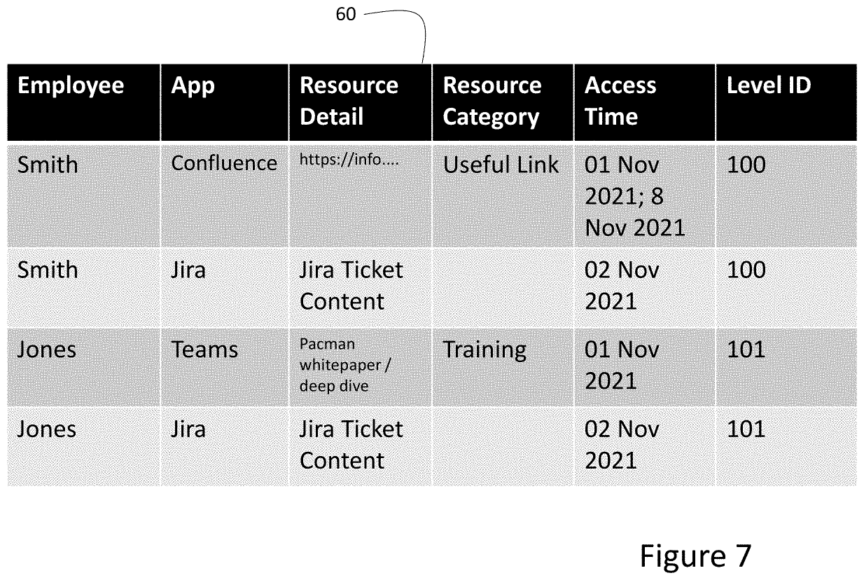

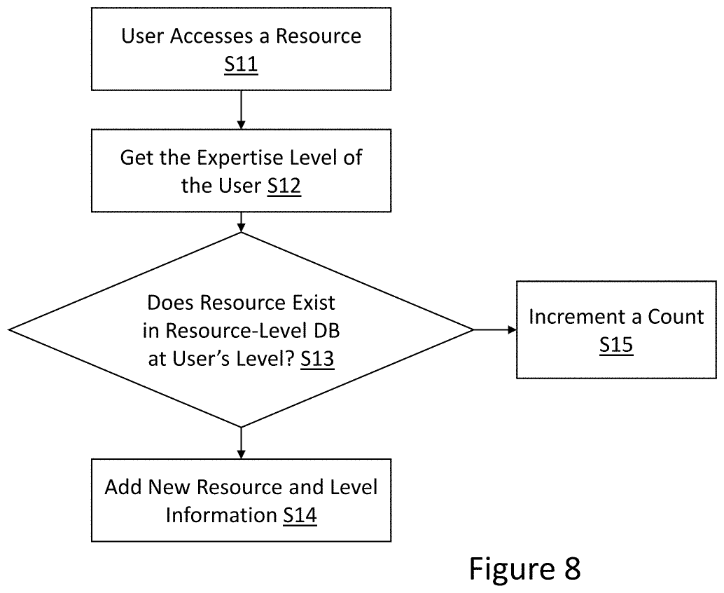

FIG. 7 depicts an illustrative resource-level database 60 that tracks which resources are used at different expertise levels (i.e., Level ID's) for all (or a group of) system users within an enterprise. In this example, resource-level database 60 details the workspace application (App), the resource detail (e.g., a link, a ticket, a whitepaper, etc.), and the category (e.g., useful link, training, etc.); and also stores the level of the user that utilized each resource item (i.e., row). FIG. 8 depicts a flow diagram of an illustrative process for updating the resource-level database 60. At S11, a user accesses a resource, e.g., launches a session, asks a question to a help bot, registers for training, etc. At S12 the expertise level of the user is obtained (e.g., from the user-level database 50) and at S13 a determination is made whether this resource already exists in the resource-level database 60 at the user's level. In no, a new record is added to the resource-level database that includes the resource and level information. If yes, a count associated with the repeated access can be incremented (e.g., a new date can be added to the existing record, as shown in the first row of FIG. 7).

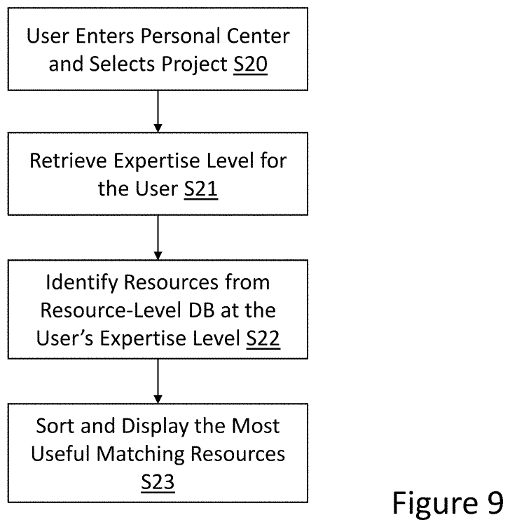

FIG. 9 depicts a flow diagram of an illustrative process for recommending resources for a user. At S20, a user launches their personal center 18 (FIGS. 1 and 2) and selects a project, and at S21 the expertise level for the user is retrieved, e.g., from the user-level database 50 (FIG. 5). At S22, resources from the resource-level database 60 (FIG. 7) that match the user's expertise level are identified. At S23, the most useful matching resources are sorted and displayed. Results may for example be sorted based on how often they are used at the given expertise level or using any other ranking criteria.

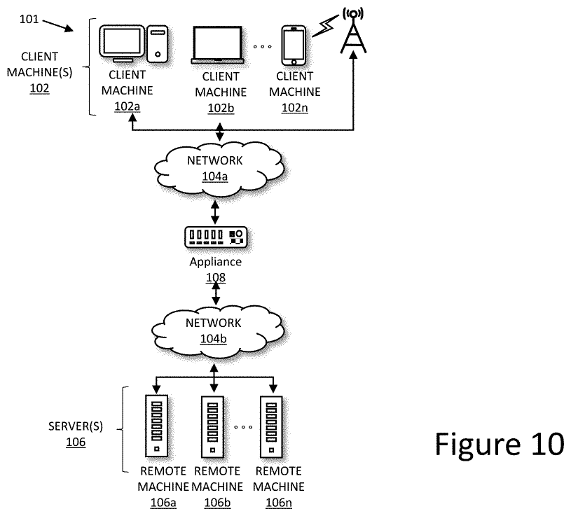

It is understood that the resource generation service 24 can be implemented in any manner, e.g., as a stand-alone system, a distributed system, within a network environment, etc. Referring to FIG. 10, a non-limiting network environment 101 in which various aspects of the disclosure may be implemented includes one or more client machines 102A-102N, one or more remote machines 106A-106N, one or more networks 104, 104′, and one or more appliances 108 installed within the computing environment 101. The client machines 102A-102N communicate with the remote machines 106A-106N via the networks 104, 104′.

In some embodiments, the client machines 102A-102N communicate with the remote machines 106A-106N via an intermediary appliance 108. The illustrated appliance 108 is positioned between the networks 104, 104′ and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104′.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104′ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

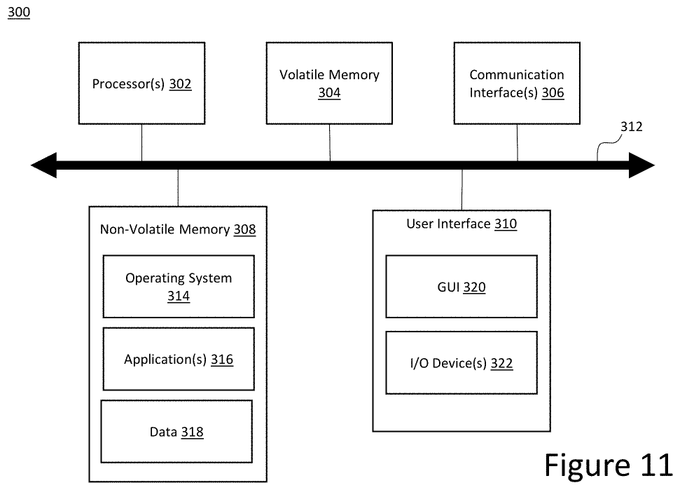

Elements of the described solution may be embodied in a computing system, such as that shown in FIG. 11 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 11 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

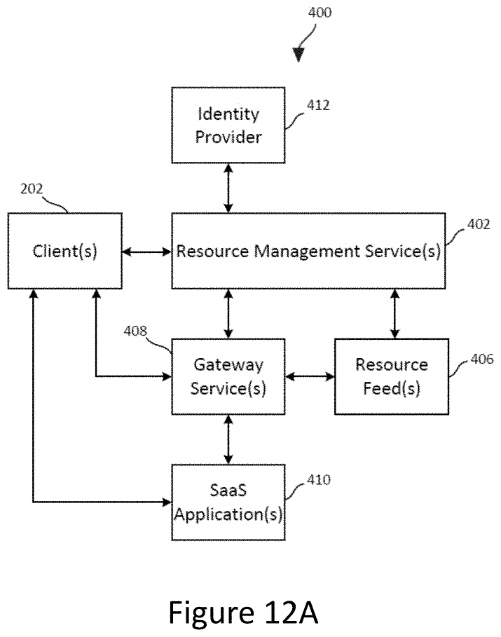

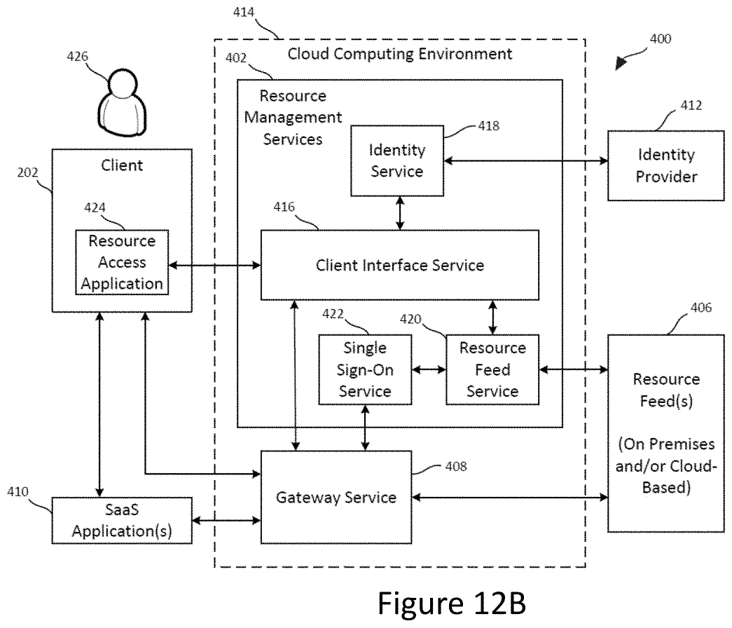

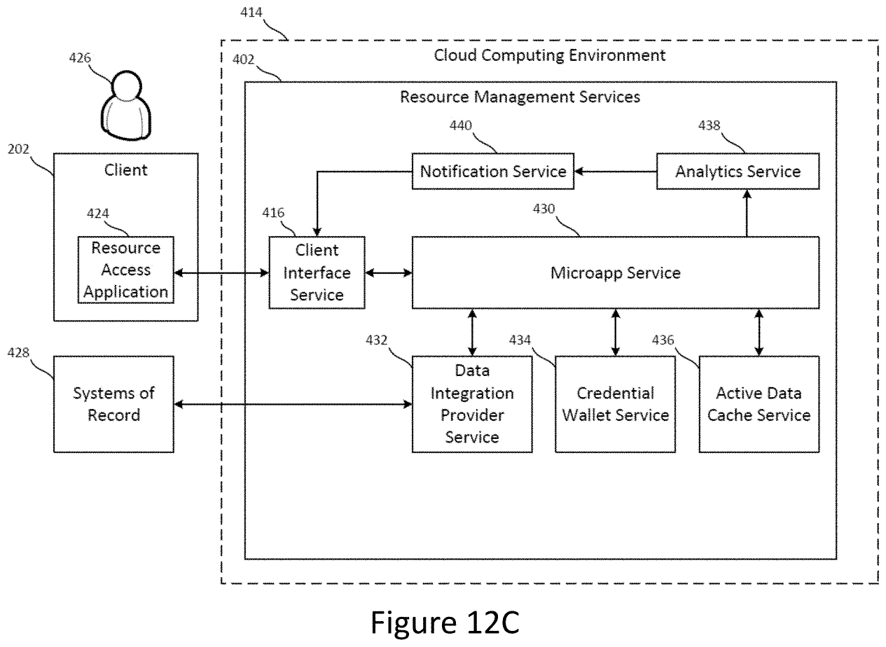

FIG. 12A is a block diagram of an example system 400 in which one or more resource management services 402 may manage and streamline access by one or more clients 202 to one or more resource feeds 406 (via one or more gateway services 408) and/or one or more software-as-a-service (SaaS) applications 410. In particular, the resource management service(s) 402 may employ an identity provider 412 to authenticate the identity of a user of a client 202 and, following authentication, identify one of more resources the user is authorized to access. In response to the user selecting one of the identified resources, the resource management service(s) 402 may send appropriate access credentials to the requesting client 202, and the client 202 may then use those credentials to access the selected resource. For the resource feed(s) 406, the client 202 may use the supplied credentials to access the selected resource via a gateway service 408. For the SaaS application(s) 410, the client 202 may use the credentials to access the selected application directly.

The client(s) 202 may be any type of computing devices capable of accessing the resource feed(s) 406 and/or the SaaS application(s) 410, and may, for example, include a variety of desktop or laptop computers, smartphones, tablets, etc. The resource feed(s) 406 may include any of numerous resource types and may be provided from any of numerous locations. In some embodiments, for example, the resource feed(s) 406 may include one or more systems or services for providing virtual applications and/or desktops to the client(s) 202, one or more file repositories and/or file sharing systems, one or more secure browser services, one or more access control services for the SaaS applications 410, one or more management services for local applications on the client(s) 202, one or more internet enabled devices or sensors, etc. Each of the resource management service(s) 402, the resource feed(s) 406, the gateway service(s) 408, the SaaS application(s) 410, and the identity provider 412 may be located within an on-premises data center of an organization for which the system 400 is deployed, within one or more cloud computing environments, or elsewhere.

FIG. 12B is a block diagram showing an example implementation of the system 400 shown in FIG. 12A in which various resource management services 402 as well as a gateway service 408 are located within a cloud computing environment 414. The cloud computing environment may, for example, include Microsoft Azure Cloud, Amazon Web Services, Google Cloud, or IBM Cloud.

For any of illustrated components (other than the client 202) that are not based within the cloud computing environment 414, cloud connectors (not shown in FIG. 12B) may be used to interface those components with the cloud computing environment 414. Such cloud connectors may, for example, run on Windows Server instances hosted in resource locations and may create a reverse proxy to route traffic between the site(s) and the cloud computing environment 414. In the illustrated example, the cloud-based resource management services 402 include a client interface service 416, an identity service 418, a resource feed service 420, and a single sign-on service 422. As shown, in some embodiments, the client 202 may use a resource access application 424 to communicate with the client interface service 416 as well as to present a user interface on the client 202 that a user 426 can operate to access the resource feed(s) 406 and/or the SaaS application(s) 410. The resource access application 424 may either be installed on the client 202, or may be executed by the client interface service 416 (or elsewhere in the system 400) and accessed using a web browser (not shown in FIG. 12B) on the client 202.

As explained in more detail below, in some embodiments, the resource access application 424 and associated components may provide the user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 424 is launched or otherwise accessed by the user 426, the client interface service 416 may send a sign-on request to the identity service 418. In some embodiments, the identity provider 412 may be located on the premises of the organization for which the system 400 is deployed. The identity provider 412 may, for example, correspond to an on-premises Windows Active Directory. In such embodiments, the identity provider 412 may be connected to the cloud-based identity service 418 using a cloud connector (not shown in FIG. 12B), as described above. Upon receiving a sign-on request, the identity service 418 may cause the resource access application 424 (via the client interface service 416) to prompt the user 426 for the user's authentication credentials (e.g., user-name and password). Upon receiving the user's authentication credentials, the client interface service 416 may pass the credentials along to the identity service 418, and the identity service 418 may, in turn, forward them to the identity provider 412 for authentication, for example, by comparing them against an Active Directory domain. Once the identity service 418 receives confirmation from the identity provider 412 that the user's identity has been properly authenticated, the client interface service 416 may send a request to the resource feed service 420 for a list of subscribed resources for the user 426.

In other embodiments (not illustrated in FIG. 12B), the identity provider 412 may be a cloud-based identity service, such as a Microsoft Azure Active Directory. In such embodiments, upon receiving a sign-on request from the client interface service 416, the identity service 418 may, via the client interface service 416, cause the client 202 to be redirected to the cloud-based identity service to complete an authentication process. The cloud-based identity service may then cause the client 202 to prompt the user 426 to enter the user's authentication credentials. Upon determining the user's identity has been properly authenticated, the cloud-based identity service may send a message to the resource access application 424 indicating the authentication attempt was successful, and the resource access application 424 may then inform the client interface service 416 of the successfully authentication. Once the identity service 418 receives confirmation from the client interface service 416 that the user's identity has been properly authenticated, the client interface service 416 may send a request to the resource feed service 420 for a list of subscribed resources for the user 426.

For each configured resource feed, the resource feed service 420 may request an identity token from the single sign-on service 422. The resource feed service 420 may then pass the feed-specific identity tokens it receives to the points of authentication for the respective resource feeds 406. Each resource feed 406 may then respond with a list of resources configured for the respective identity. The resource feed service 420 may then aggregate all items from the different feeds and forward them to the client interface service 416, which may cause the resource access application 424 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 410 to which the user 426 has subscribed. The lists of local applications and the SaaS applications 410 may, for example, be supplied by resource feeds 406 for respective services that manage which such applications are to be made available to the user 426 via the resource access application 424. Examples of SaaS applications 410 that may be managed and accessed as described herein include Microsoft Office 365 applications, SAP SaaS applications, Workday applications, etc.

For resources other than local applications and the SaaS application(s) 410, upon the user 426 selecting one of the listed available resources, the resource access application 424 may cause the client interface service 416 to forward a request for the specified resource to the resource feed service 420. In response to receiving such a request, the resource feed service 420 may request an identity token for the corresponding feed from the single sign-on service 422. The resource feed service 420 may then pass the identity token received from the single sign-on service 422 to the client interface service 416 where a launch ticket for the resource may be generated and sent to the resource access application 424. Upon receiving the launch ticket, the resource access application 424 may initiate a secure session to the gateway service 408 and present the launch ticket. When the gateway service 408 is presented with the launch ticket, it may initiate a secure session to the appropriate resource feed and present the identity token to that feed to seamlessly authenticate the user 426. Once the session initializes, the client 202 may proceed to access the selected resource.

When the user 426 selects a local application, the resource access application 424 may cause the selected local application to launch on the client 202. When the user 426 selects a SaaS application 410, the resource access application 424 may cause the client interface service 416 request a one-time uniform resource locator (URL) from the gateway service 408 as well a preferred browser for use in accessing the SaaS application 410. After the gateway service 408 returns the one-time URL and identifies the preferred browser, the client interface service 416 may pass that information along to the resource access application 424. The client 202 may then launch the identified browser and initiate a connection to the gateway service 408. The gateway service 408 may then request an assertion from the single sign-on service 422. Upon receiving the assertion, the gateway service 408 may cause the identified browser on the client 202 to be redirected to the logon page for identified SaaS application 410 and present the assertion. The SaaS may then contact the gateway service 408 to validate the assertion and authenticate the user 426. Once the user has been authenticated, communication may occur directly between the identified browser and the selected SaaS application 410, thus allowing the user 426 to use the client 202 to access the selected SaaS application 410.

In some embodiments, the preferred browser identified by the gateway service 408 may be a specialized browser embedded in the resource access application 424 (when the resource application is installed on the client 202) or provided by one of the resource feeds 406 (when the resource application 424 is located remotely), e.g., via a secure browser service. In such embodiments, the SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have the client interface service 416 send the link to a secure browser service, which may start a new virtual browser session with the client 202, and thus allow the user to access the potentially harmful linked content in a safe environment.

In some embodiments, in addition to or in lieu of providing the user 426 with a list of resources that are available to be accessed individually, as described above, the user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 426 of something that requires the user's attention (e.g., approval of an expense report, new course available for registration, etc.).

FIG. 12C is a block diagram similar to that shown in FIG. 12B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 12C may enable the provision of a streamlined resource activity feed and/or notification process for a client 202. In the example shown, in addition to the client interface service 416 discussed above, the illustrated services include a microapp service (or simply “microservice”) 430, a data integration provider service 432, a credential wallet service 434, an active data cache service 436, an analytics service 438, and a notification service 440. In various embodiments, the services shown in FIG. 12C may be employed either in addition to or instead of the different services shown in FIG. 12B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 424 without having to launch the native application. The system shown in FIG. 12C may, for example, aggregate relevant notifications, tasks, and insights, and thereby give the user 426 a dynamic productivity tool. In some embodiments, the resource activity feed may be intelligently populated by utilizing machine learning and artificial intelligence (AI) algorithms. Further, in some implementations, microapps may be configured within the cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 12C, the systems of record 428 may represent the applications and/or other resources the resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 402, and in particular the data integration provider service 432, may, for example, support REST API, JSON, OData-JSON, and 6ML. As explained in more detail below, the data integration provider service 432 may also write back to the systems of record, for example, using OAuth2 or a service account.

In some embodiments, the microapp service 430 may be a single-tenant service responsible for creating the microapps. The microapp service 430 may send raw events, pulled from the systems of record 428, to the analytics service 438 for processing. The microapp service may, for example, periodically pull active data from the systems of record 428.

In some embodiments, the active data cache service 436 may be single-tenant and may store all configuration information and microapp data. It may, for example, utilize a per-tenant database encryption key and per-tenant database credentials.

In some embodiments, the credential wallet service 434 may store encrypted service credentials for the systems of record 428 and user OAuth2 tokens.

In some embodiments, the data integration provider service 432 may interact with the systems of record 428 to decrypt end-user credentials and write back actions to the systems of record 428 under the identity of the end-user. The write-back actions may, for example, utilize a user's actual account to ensure all actions performed are compliant with data policies of the application or other resource being interacted with.

In some embodiments, the analytics service 438 may process the raw events received from the microapps service 430 to create targeted scored notifications and send such notifications to the notification service 440.

Finally, in some embodiments, the notification service 440 may process any notifications it receives from the analytics service 438. In some implementations, the notification service 440 may store the notifications in a database to be later served in a notification feed. In other embodiments, the notification service 440 may additionally or alternatively send the notifications out immediately to the client 202 as a push notification to the user 426.

In some embodiments, a process for synchronizing with the systems of record 428 and generating notifications may operate as follows. The microapp service 430 may retrieve encrypted service account credentials for the systems of record 428 from the credential wallet service 434 and request a sync with the data integration provider service 432. The data integration provider service 432 may then decrypt the service account credentials and use those credentials to retrieve data from the systems of record 428. The data integration provider service 432 may then stream the retrieved data to the microapp service 430. The microapp service 430 may store the received systems of record data in the active data cache service 436 and also send raw events to the analytics service 438. The analytics service 438 may create targeted scored notifications and send such notifications to the notification service 440. The notification service 440 may store the notifications in a database to be later served in a notification feed and/or may send the notifications out immediately to the client 202 as a push notification to the user 426.

In some embodiments, a process for processing a user-initiated action via a microapp may operate as follows. The client 202 may receive data from the microapp service 430 (via the client interface service 416) to render information corresponding to the microapp. The microapp service 430 may receive data from the active data cache service 436 to support that rendering. The user 426 may invoke an action from the microapp, causing the resource access application 424 to send that action to the microapp service 430 (via the client interface service 416). The microapp service 430 may then retrieve from the credential wallet service 434 an encrypted Oauth2 token for the system of record for which the action is to be invoked, and may send the action to the data integration provider service 432 together with the encrypted Oauth2 token. The data integration provider service 432 may then decrypt the Oauth2 token and write the action to the appropriate system of record under the identity of the user 426. The data integration provider service 432 may then read back changed data from the written-to system of record and send that changed data to the microapp service 430. The microapp service 432 may then update the active data cache service 436 with the updated data and cause a message to be sent to the resource access application 424 (via the client interface service 416) notifying the user 426 that the action was successfully completed.

In some embodiments, in addition to or in lieu of the functionality described above, the resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 402 may, for example, parse these requests and respond because they are integrated with multiple systems on the back-end. In some embodiments, users may be able to interact with the virtual assistance through either the resource access application 424 or directly from another resource, such as Microsoft Teams. This feature may allow employees to work efficiently, stay organized, and deliver only the specific information they're looking for.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

1. A system, comprising:
a memory; and
a processor coupled to the memory and configured to suggest resources for users according to a process that includes:
extracting project and keyword data resulting from interactions between a user and system applications;
evaluating the project and keyword data to determine an expertise level of the user for at least one project;
in response to a determined expertise level for the at least one project, determining a set of resources for the user based on historical resource interactions of system users having a common expertise level; and
outputting links to the set of resources for the user.

2. The system of claim 1, wherein the set of resources include: useful applications, useful links, frequently asked questions, and training resources.

3. The system of claim 1, wherein the expertise level is selected from a group of levels that include: novice, junior, intermediate, senior, and expert.

4. The system of claim 1, wherein historical resource interactions include at least one of: applications used, links accessed, problems reported, help channels utilized, questions asked and training resources used.

5. The system of claim 1, further comprising providing an interface mechanism for allowing the user to manually select the expertise level.

6. The system of claim 1, wherein the links are outputted to a virtual workspace on a client device.

7. The system of claim 1, wherein evaluating the project and keyword data includes determining a frequency with which keywords are utilized by the user for an associated project.

8. The system of claim 7, wherein the expertise level for the associated project is increased when a threshold number of keywords utilized by the user are detected.

9. The system of claim 1, wherein interactions with the system applications are done with a single sign-on (SSO) authentication process.

10. The system of claim 9, wherein the project and keyword data is periodically collected from content stored by the system applications.

11. A method for suggesting resources to users in a virtual workspace infrastructure, comprising:
extracting project and keyword data from interactions between a user and workspace applications;
evaluating the project and keyword data to determine an expertise level of the user for at least one project;
in response to a determined expertise level for the at least one project, determining a set of resources for the user based on historical workspace interactions of workspace users having a common expertise level; and
outputting links to the set of resources to a virtual workspace of the user.

12. The method of claim 1, wherein the set of resources include: useful applications, useful links, frequently asked questions, and training resources.

13. The method of claim 11, wherein the expertise level is selected from a group of levels that include: novice, junior, intermediate, senior, and expert.

14. The method of claim 11, wherein historical workspace interactions include at least one of: applications used, links accessed, problems reported, help channels utilized, questions asked and training resources used.

15. The method of claim 11, further comprising providing an interface mechanism for allowing the user to manually select the expertise level.

16. The method of claim 11, wherein the links are outputted to the virtual workspace on a client device.

17. The method of claim 11, wherein evaluating the project and keyword data includes determining a frequency with which keywords are utilized by the user for an associated project.

18. The method of claim 17, wherein the expertise level for the associated project is increased when a threshold number of keywords utilized by the user are detected.

19. The method of claim 11, wherein interactions with the workspace applications are done with a single sign-on (SSO) authentication process.

20. The method of claim 19, wherein the project and keyword data is periodically collected from content stored by the workspace applications.
